(19) United States
(12) Patent Application Publication
(10) Pub. No.: US 2004/0185213 A1
(43) Pub. Date: Sep. 23, 2004

(54) Security panel

(76) Inventors: Anthony John Skelton, Wolverhampton (GB); Murray Roy Orpin, Gloucestershire (GB); Denis Drury, Deryshire (GB)

Correspondence Address: QUARLES & BRADY STREICH LANG, LLP, ONE SOUTH CHURCH AVENUE, SUITE 1700, TUCSON, AZ, 85701-1621, US

(21) Appl. No.: 10/476,713

(22) PCT Filed: May 3, 2002
(86) PCT No.: PCT/GB02/02019

(30) Foreign Application Priority Data
May 3, 2001 (GB) 0110873.7

(51) Int. Cl. B32B 3/00

(52) U.S. Cl. 428/60; 428/192

(57) ABSTRACT

A security panel (10) comprises a body of non foamed elastomeric polyurethane (39) containing 37-47% by volume of hardwood chips. The panel has front and rear sheet steel panels (11, 12) forming a skin or shell, and encloses embedded in the body of polyurethane and wood chip (38) as an array of reinforcing metal coils (15).

This invention relates to security panels e.g. made of flame retardant materials as used for example in construction of strong rooms and secure enclosures.

The purpose of a strong room or other secure enclosure is to prevent unauthorised access to the contents of the enclosure, and this must be capable of withstanding attacks which try to breach the panelling using available tools, including power hammers, various types of saws, oxyacetylene cutting torches and thermic lances. It is known to construct strong rooms from concrete. To withstand attacks using available powered percussion tools and drills, it is necessary for the concrete panels to have thickness of over for example 300-400 mm. Concrete is a high density material; and therefore such panels are extremely massive and must be assembled using heavy lifting equipment such as construction cranes.

It is possible to reduce the weight of panels, and introduce resilience which helps to resist attack by percussive tools and drills by substituting a resin bounded aggregate structure for the lime-sand mortar bounded aggregate structure of concrete, the preferred resin being an elastomer. The elastomer gives impact resistance whilst the aggregate gives resistance to cutting tools. An example of such a material is disclosed in EP-A-899,406.

The major defect of such elastomer bonded aggregate structures is a vulnerability to thermal attack using oxyacetylene torches, or thermic lances.

It is an object of the present invention to provide a material which can produce security panelling which has improved resistance to thermal cutting torches and lances, yet has good physical properties including strength and relatively low density. The latter is an important advantage for construction of strong rooms or secure enclosures above ground level, since the weight imposed by concrete panelling requires special structural reinforcement of buildings if the enclosure is to be built above basement or ground floor level.

According to the invention, a security panel is made from fragments of timber in a matrix of a suitable resin.

The timber fragments are advantageously of hardwood, which may be obtained from temperate or tropical deciduous species. Conveniently, the fragments may be obtained as scrap of suitable mean dimensions produced by furniture or other wood utilising industries. Quercus (oak) species have at present been found to be particularly useful, whilst it has been found that larger sizes of fragments are most suitable. Typical available scrap consists predominantly of wood fragments having a longest dimension of 30-40 mm for example.

The resin used is preferably an elastomeric non-cellular (un-foamed) polyurethane composition, but can be a cellular (foamed) material. The polyurethane may advantageously have an excess of diicsocyanate groups to bond with the free hydroxyl groups in the lignin of the wood fragments. This provides for actual chemical bonding between the matrix and the aggregate of wood fragments, which has advantages under percussive attack wherein any adhesive bond between mineral aggregate particles and the resin is disrupted by the shocks and vibrations imposed on the composite material. Further, mineral particles tend to shatter or pulverise and thus can be removed by repeated hammering. On the other hand, the chemical bond between the wood fragments and the polyurethane matrix is maintained, and the innate elasticity of the wood fibres help sustain their integrity.

In order to resist mechanical attack, with hammers, cutting tools and the like, the panel preferably has an outer skin of sheet steel on at least one, and preferably both major faces of the panel, and the skin may advantageously completely enclose the panel.

The panel may further include, within the interior of the panel a reinforcing structure of metal, preferably steel coils which are embedded in the matrix of polyurethane and timber fragments. The coils are preferably disposed so as to be axially parallel and interlinked for example by passing adjacent coils through one another. These coils create a labyrinthine reinforcement which increases resistance to attack by drilling.

The panel may have a stepped edge for nesting with a corresponding stepped edge of an adjacent panel, and coils of reduced diameter may be enclosed within the steps of the stepped edges. Preferred embodiments of security panel according to the invention will now be further described by way of example with reference to the accompanying drawings, wherein:—

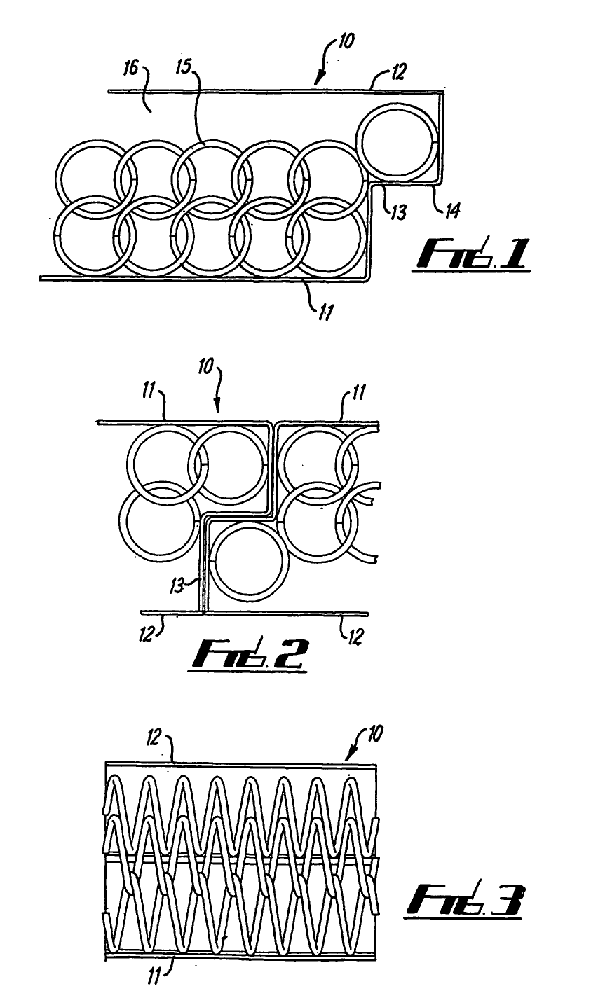

FIG. 1 is a fragmentary sectional view of an edge part of a first embodiment of security panel according to the invention;

FIG. 2 is a view similar to FIG. 1, showing the edges of two panels according to FIG. 1 nested together;

FIG. 3 is a sectional view on line III-III of FIG. 1;

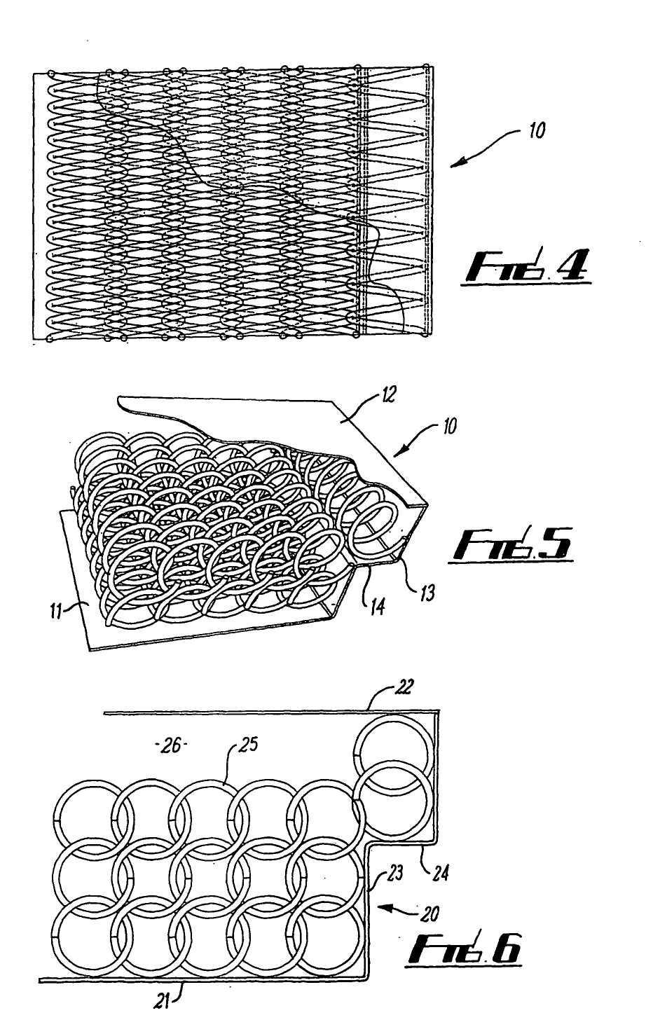

FIG. 4 Is a sectional view on line IV-IV of FIG. 1;

FIG. 5 is a partly sectional and cut away perspective view of the edge region of the panel of FIG. 1;

FIG. 6 is a sectional view similar to FIG. 1 of an edge region of a second embodiment of security panel according to the invention;

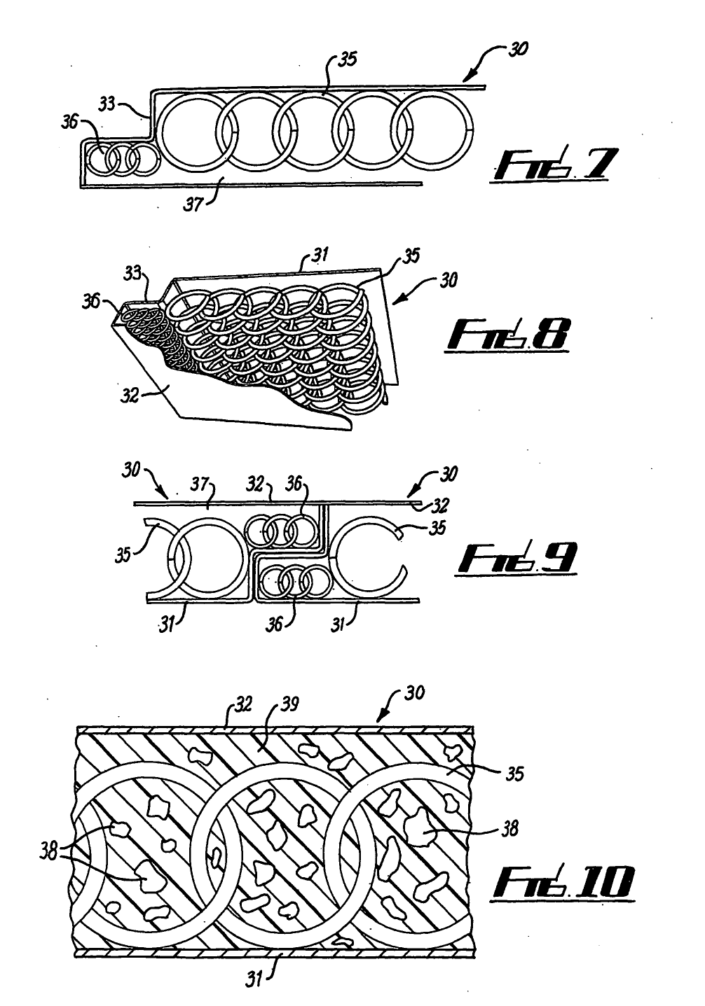

FIG. 7 is a sectional view similar to FIGS. 1 and 6 of an edge region of a third embodiment of security panel according to the invention;

FIG. 8 is a perspective view similar to FIG. 5 of the third embodiment of security panel;

FIG. 9 is a sectional view similar to FIG. 2 showing the nesting together of edge regions of two panels according to the third embodiment of the invention; and

FIG. 10 is a diagrammatic section showing the FIG. 7 embodiments filled with a matrix of polyurethane elastomer with timber fragments.

Referring first to FIGS. 1 to 5 of the drawings, a security panel 10 comprises a metal outer skin of e.g. steel sheet comprising front and rear face panels 11, 12 and edge parts 13 formed as flanges of the front panel 11, so as to completely sheath the panel 10 in the outer skin.

The edge parts 13 are stepped as at 14 to nest with correspondingly stepped edge parts of a similar panel, as shown on FIG. 2.

The interior of the panel contains reinforcement members in the form of steel coils 15, which are interlinked and extend parallel within the interior for example virtually between the front and rear face panels, or alternatively horizontally. The steel coils help to frustrate attack by drilling by creating a labyrinthine reinforcing structure within the panel. In the FIG. 1 to 5 embodiment, the coils are arranged in two rows or banks of parallel interlinked coils, with one coil in the stepped part of the panel edge, and a void 16 towards the rear panel 12 of the security panel. The entire volume within the panel, including interstices between the coils 15 and the void 16 is filled with a composite material consisting of timber fragments in a size range of 15-20 mm, and not more than 30-90 mm in length and width/thickness 6-10 mm. The timber may be chips of an oak species, dried to 0-5% moisture content, and embedded in a solid non-foamed polyurethane elastomeric material. The woodchips may compose 37-47% by volume of the timber/polyurethane composite, and the composite occupies all of the interior of the panel not occupied by the coils 15.

FIG. 6 differs from FIGS. 1 to 5 in that it shows a panel 20 of greater cross sectional depth, comprising a front panel 21, rear panel 22, edge pieces 23 with step 29, and three tiers or banks of interlinked steel springs 25 within the panel with a void space 26 towards the back. The interior of the panel is again completely filled, including the interstices within the coils with a composite comprising polyurethane elastomeric matrix and dried oak wood chips.

FIGS. 7 to 10 show views of a third embodiment of panel 30 of reduced thickness. This again comprises front and rear face panels 21, 32 of sheet steel, edge pieces 33, and a single tier of steel coils 35. Coils 36 of reduced diameter are present in the stepped part of the edge 33, and there is a void 37 towards the rear panel 32. As shown in FIG. 10, the interior volume of the panel 30 is completely filled with a timber/polyurethane composite, including oak wood chips 38 and a matrix 39 of solid non-foamed polyurethane, similar to that described in connection with FIGS. 1 to 5, or a composition as further described below.

A test sample of panel without interior reinforcement was fabricated by casting a mixture of polyurethane elastomeric resin with wood fragments in the form of oak wood scrap and off cuts having a mean longest dimension of about 10-20 up to 30-40 mm. Fragment shapes vary from elongate, to quasi-cuboid, and shapes were generally irregular. The panel was moulded to a thickness of about 100 mm and subjected to tests including attack with a thermic lance and with an acetylene torch.

In these flame tests it was found, counter-intuitively, that pyrolysis of the resin and of the wood quickly produced a char layer consisting generally of a carbon residue formed by the skeletons of long chain molecules left after driving off of more volatile elements such as hydrogen, oxygen and nitrogen. This char layer formed an effective thermal insulation layer, preventing degradation of underlying resin and wood fragments enabling the integrity of the overall structure to be retained. Continued attack only served to ablate the char layer relatively slowly due to oxidisation of carbon to CO and CO₂.

It is possible that some synergy between the resin and the resinous component of the wood contributed to the production of a flame resistant residue.

The optimum composition of the polyurethane matrix has not yet been established. It is believed that an excess of diisocyanate groups over hydroxyl groups (present as polyol and/or polyester) may help to promote bonding with lignin in the wood fragments. The effect of an excess of hydroxyl groups, or of a stochiometric balance has not been determined, and may be academic as it is likely that even with optimum blending, in practise radicals of both species remain un-reacted in the curing reaction, leaving diisocyonate groups free to react with hydroxyl groups of the lignin, even when there is a theoretical polyester/polyol excess.

In a second embodiment, a panel similar to the above further includes a layer on one face of mineral aggregate particles, embedded in the matrix to provide an outer layer resistant to mechanical attack, coupled with a thicker body of matrix containing wood fragments.

The mineral aggregate particles can be of crushed rock, such as granite, or hard mineral particles such as alumina in one of its mineral forms. The wood fragments may be of oak, but could be of any other tropical or temperate hardwood. So far as is known softwoods such as conifers are not likely to be effective, but may be used if trials show that any species of soft wood are suitable.

The material may be formed into panels from 75-200 mm thickness depending upon the application intended. The panels will give a much less massive alternative to concrete panels having similar strength, and has improved resistance to thermal attack with respect to known panels made of mineral aggregate in an elastomeric matrix.

The material may if desired be used in a sandwich construction including one or more steel plates.

The polyurethane resin material may advantageously include an additive such as calcium metasiliacate. This latter material is believed to enhance properties of the matrix on fusion under high temperatures.

In place of the solid (unfoamed) polyurethane preferred, it may be appropriate in some cases to use a foamed polyurethane matrix.

1. A security panel comprising fragments of timber in a matrix of a resin material.

2. A panel according to claim 1 wherein the resin material comprises an elastomeric non cellular (unfoamed) polyurethane composition.

3. A panel according to claim 1 wherein the resin material comprises a cellular (foamed) polyurethane composition.

4. A panel according to claim 1, 2 or 3 wherein the timber fragments have a longer dimension of up to 40 mm.

5. A panel according to claim 4 wherein said timber fragments are of a temperature or tropical hardwood.

6. A panel according to claim 5 wherein said timber fragments are of a quercus (oak) species.

7. A panel according to claim 2 or 3 wherein said elastomeric polyurethane composition an excess of diisocyanate groups for bonding chemically with free hydroxyl groups in lignin of the timber fragments.

8. A panel according to claim 1, which further comprises an outer skin of sheet steel on at least one face of the panel.

9. A panel according to claim 8, wherein both major surfaces of the panel are clad with an outer skin of sheet steel.

10. A panel according to claim 9 wherein the interior of the panel within the outer skin contains a reinforcing structure of metal coils, embedded in the said matrix.

11. A panel according to claim 10 wherein the coils are disposed axially parallel and are interlinked.

12. A panel according to claim 10, which includes a stepped edged for nesting with a corresponding stepped edge of an adjacent panel.

13. A panel according to claim 12, wherein metal coils of reduced diameter are enclosed within the steps of the stepped edges.
